(19) United States
(12) Patent Application Publication
(10) Pub. No.: US 2015/0309991 A1
(43) Pub. Date: Oct. 29, 2015

(54) INPUT SUPPORT DEVICE, INPUT SUPPORT METHOD, AND INPUT SUPPORT PROGRAM

(71) Applicant: RAKUTEN, INC., Shinagawa-ku, Tokyo (JP)

(72) Inventors: Yuta HAYASHIBE, Shinagawa-ku (JP); Masato HAGIWARA, Shinagawa-ku (JP)

(73) Assignee: Rakuten, Inc., Shinagawa-ku, Tokyo (JP)

(21) Appl. No.: 14/650,220

(22) PCT Filed: Aug. 9, 2013
(86) PCT No.: PCT/JP2013/071712

§ 371 Date: Jun. 5, 2015

Related U.S. Application Data
(60) Provisional application No. 61/734,026, filed on Dec. 6, 2012.

(51) Int. Cl. G06F 17/27; G06F 17/30

(52) U.S. Cl. CPC G06F 17/2785; G06F 17/30705; G06F 17/30684

(57) ABSTRACT

An input support device according to one embodiment includes a receiving unit, a search unit and an output unit. The receiving unit receives an input letter string in Roman letters. The search unit performs first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string. The output unit outputs a result of the first processing and a result of the second processing as input candidates.

### TECHNICAL FIELD

One aspect of the present invention relates to an input support device, an input support method, and an input support program.

### BACKGROUND ART

Systems that support the input of another language (for example, English language for Japanese people) have been known. For example, in the character input device disclosed in Patent literature 1 below, when a copied letter string is not a correct English spelling, the letter string copied in a conversion buffer is romanized, converted into kana and stored in a kana buffer. When a result of kana conversion has some meaning in Japanese, the English word corresponding to the meaning is retrieved and stored.

### CITATION LIST

### Patent Literature

PTL 1: JP H11-7448 A

### SUMMARY OF INVENTION

### Technical Problem

However, in the case of using the device disclosed in the above-described Patent literature 1, a user needs to specify to the device whether an alphabetical letter string input by the user should be recognized as an English word or recognized as a romanized Japanese word. Thus, there is a need for a mechanism that allows input of a target language word/phrase without need for a user to specify the language of an input letter string.

### Solution to Problem

An input support device according to one aspect of the present invention includes a receiving unit configured to receive an input letter string in Roman letters, a search unit configured to perform first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string, and an output unit configured to output a result of the first processing and a result of the second processing as input candidates.

An input support method according to one aspect of the present invention is an input support method performed by an input support device, the method including a receiving step of receiving an input letter string in Roman letters, a search step of performing first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string, and an output step of outputting a result of the first processing and a result of the second processing as input candidates.

An input support program according to one aspect of the present invention causes a computer to implement a receiving unit configured to receive an input letter string in Roman letters, a search unit configured to perform first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string, and an output unit configured to output a result of the first processing and a result of the second processing as input candidates.

According to the above aspects, processing that searches for words/phrases with an input letter string without translation and processing of translation based on the input letter string are performed, and words/phrases obtained from those processing (words/phrases in a first language) are all output as input candidates. In this manner, because a plurality of systems of processing are performed for one input letter string and search results of the both are output, a user can input a target language word/phrase without specifying the language of an input letter string.

In the input support program according to another aspect, the input letter string may contain a plurality of words, the search unit may perform the first processing and the second processing for each of the plurality of words, and the output unit may output a common word/phrase in the first language retrieved with all of the plurality of words as the input candidates. By searching for input candidates using all of the words that form the input letter string, it is possible to present the word/phrase which a user intends to input with high probability.

In the input support program according to another aspect, the common word/phrase in the first language selected by a user may replace the whole input letter string, and thereby input of the selected word/phrase is confirmed. By this replacement, a user can immediately proceed to the next editing work.

In the input support program according to another aspect, the input letter string may contain a plurality of words, and the output unit may output words/phrases in the first language retrieved with a certain word among the plurality of words as the input candidates. By searching for input candidates using a certain word only, it is possible to avoid the situation where too many or too few words/phrases in the first language are extracted.

In the input support program according to another aspect, the certain word may be a word located at an end of the input letter string.

In the input support program according to another aspect, the word/phrase in the first language selected by a user may replace only the word used as search conditions for the selected word/phrase among the plurality of words, and thereby input of the selected word/phrase may be confirmed. By such replacement, a user can find which word is replaced.

In the input support program according to another aspect, the input candidates may include a word/phrase in the first language to which information indicating an unconfirmed part is added, and when input of the word/phrase having the unconfirmed part is confirmed, a focus may be set on the unconfirmed part. By setting the position of the focus in this manner, a user can immediately proceed to the next editing work without performing an operation of moving a cursor or the like.

In the input support program according to another aspect, the input candidates may include a word/phrase in the first language to which information indicating an unconfirmed part is added, and the input support device may further include an additional processing unit configured to, when input of the word/phrase having the unconfirmed part is confirmed, acquire words/phrases likely to be inserted into the unconfirmed part and outputs the acquired words/phrases as additional input candidates. Immediately after the input of a word/phrase having an unconfirmed part is confirmed, candidates for a word/phrase that can be inserted into the unconfirmed part are presented, and therefore a user can more easily create a sentence or sentences.

In the input support program according to another aspect, the additional processing unit may acquire words/phrases likely to be inserted into the unconfirmed part by referring to a specified storage unit storing correspondence between an unconfirmed part of a word/phrase and words/phrases that can be inserted into the unconfirmed part.

In the input support program according to another aspect, the additional processing unit may acquire words/phrases likely to be inserted into the unconfirmed part by referring to a specified storage unit storing a corpus of at least one of the first language and the second language.

In the input support program according to another aspect, the additional input candidates may be displayed in an order according to the number of appearances in the corpus. By setting the order of display in this manner, a word that is highly likely to be selected can be presented to a user in preference to a word that is less likely to be selected.

In the input support program according to another aspect, the additional processing unit may analyze a confirmed letter string located before the input letter string and thereby estimates a word/phrase likely to be inserted into the unconfirmed part. By estimating a word/phrase likely to be inserted into the unconfirmed part based on a sentence or sentences already input, it is possible to present in advance words/phrases which a user who inputs the sentence or sentences is likely to be about to input.

In the input support program according to another aspect, in the additional input candidates, a word/phrase estimated by analysis of the confirmed letter string may be displayed in preference to a word/phrase not estimated by the analysis. By setting the order of display in this manner, a word that is highly likely to be selected can be presented to a user in preference to a word that is less likely to be selected.

In the input support program according to another aspect, when there are a plurality of unconfirmed parts in a word/phrase in the first language contained in the input candidates, the additional processing unit may acquire the additional input candidates for each of the unconfirmed parts and acquire combination information indicating a natural combination between a word/phrase likely to be inserted into a first unconfirmed part and a word/phrase likely to be inserted into a second unconfirmed part, and output the combination information together with the additional input candidates for each of the unconfirmed parts, and in response to a user operation in one of the first and second unconfirmed parts, a word/phrase likely to be inserted into another one of the unconfirmed parts may be presented based on the combination information. By presenting a natural combination of words/phrases in this manner, a user can easily create a natural sentence or sentences.

In the input support program according to another aspect, the input candidates may be sorted into a column of words and a column of phrases and displayed. By displaying the input candidates after sorting them into at least two groups, a user can easily find and select a desired word/phrase.

In the input support program according to another aspect, the phrases may be further sorted into a plurality of columns by meanings and displayed. By sorting the phrases by the meaning and presenting them, a user can easily find and select a desired word/phrase.

In the input support program according to another aspect, the input candidates may be sorted into a plurality of columns by meanings and displayed. By sorting the input candidate words by the meaning and presenting them, a user can easily find and select a desired word/phrase.

In the input support program according to another aspect, the input candidates may be displayed so that columns are scrolled independently of one another. By such scrolling, a user can overlook the words/phrases in one specific column, keeping looking the words/phrases in the other columns.

### Advantageous Effects of Invention

According to one aspect of the present invention, a user can input a target language word/phrase without specifying the language of an input letter string.

### BRIEF DESCRIPTION OF DRAWINGS

FIG. 1 is a view showing a concept of input support according to an embodiment.

FIG. 2 is a block diagram showing a functional configuration of an input support system according to a first embodiment.

FIG. 3 is a view showing a hardware configuration of an input support server.

FIG. 4 is a sequence chart showing an operation of the input support system according to the first embodiment.

FIG. 5 is a view illustrating a series of operations of an editor.

FIG. 6 is a view illustrating a series of operations of an editor.

FIG. 7 is a view illustrating a series of operations of an editor.

FIG. 8 is a view illustrating a series of operations of an editor.

FIG. 9 is a view illustrating a series of operations of an editor.

FIG. 10 is a view illustrating a series of operations of an editor.

FIG. 11 is a view illustrating a series of operations of an editor.

FIG. 12 is a view illustrating a series of operations of an editor.

FIG. 13 is a view illustrating a series of operations of an editor.

FIG. 14 is a view showing a configuration of an input support program according to the first embodiment.

FIG. 15 is a block diagram showing a functional configuration of an input support system according to a second embodiment.

FIG. 16 is a sequence chart showing an operation of the input support system according to the second embodiment.

FIG. 17 is a view showing a state where additional input candidates are displayed on an editor.

FIG. 18 is a view showing a configuration of an input support program according to the second embodiment.

FIG. 19 is a block diagram showing a functional configuration of an input support system (user terminal) according to an alternative example.

### DESCRIPTION OF EMBODIMENTS

Embodiments of the present invention are described hereinafter in detail with reference to the appended drawings. Note that, in the description of the drawings, the same or equivalent elements are denoted by the same reference symbols, and the redundant explanation thereof is omitted.

The term “alphabets” in this specification means a generic name for a set of letters in Western European language presented in a certain order. Further, the term “Roman letters” means letters used when a certain language is written in Latin. In this specification, writing a certain language using Roman letters is referred to as “romanization”.

### First Embodiment

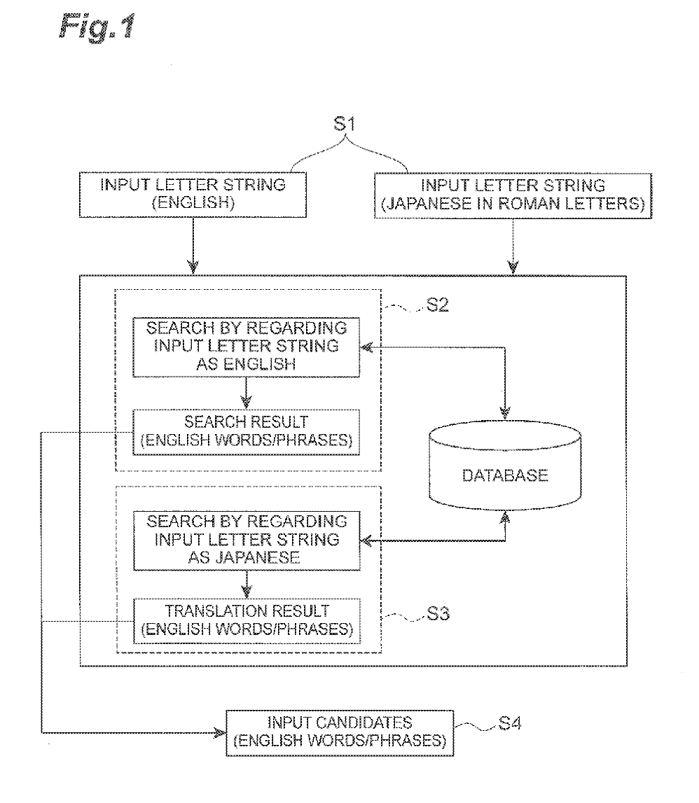

The functions and configuration of an input support system (which is also referred to hereinafter simply as “system”) 1 according to a first embodiment are described with reference to FIGS. 1 to 3. The system 1 is a computer system that supports English input. Using the system 1, it is expected that a user who is not familiar with English can easily create English text.

As shown in FIG. 1, when inputting English text, a user may input an English letter string or input a Japanese letter string by Roman letters input (Step S1). In other words, a user does not need to make the system 1 recognize in advance the language of a letter string to be input.

For example, when it is desired to obtain the English phrase “e-mail the address of” in the end, a user may input the Japanese word “okuru” or may input the English word “e-mail”.

After a letter string is input, the input support system 1 performs two types of processing by using the letter string. One is processing that, regarding the input letter string as English, retrieves a word or a phase containing the letter string from a database (Step S2). The other one is processing that, regarding the input letter string as Japanese, acquires the English translation related to the letter string from a database (Step S3). Then, the input support system 1 presents the results obtained by those two processing as input candidates to a user (Step S4). Because English words/phrases are obtained in both of the two steps S2 and S3, the words/phrases presented to a user as the input candidates are all English. Note that, “word/phrase” in this specification indicates one or both of a word and a phrase.

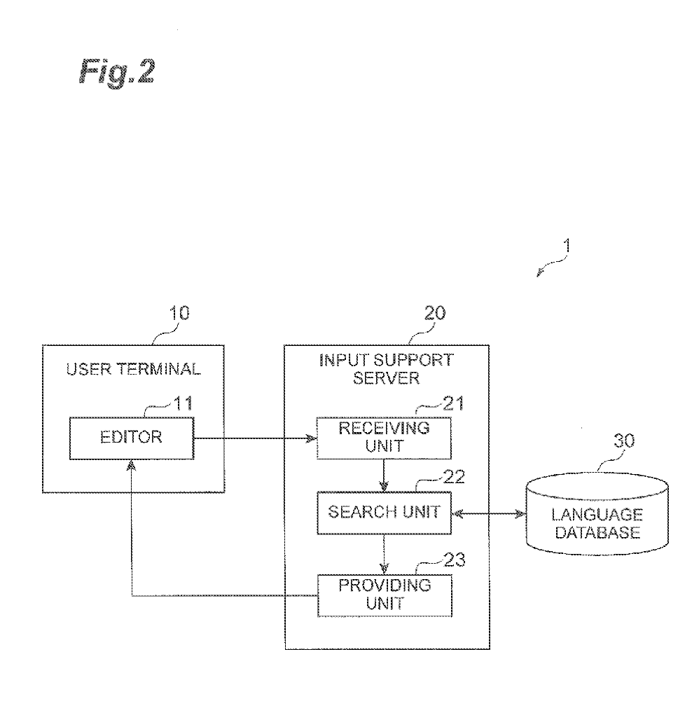

As shown in FIG. 2, the input support system 1 includes a user terminal 10, an input support server (input support device) 20, and a language database (storage unit) 30. The user terminal 10 and the input support server 20 can communicate in two way with each other through a communication network such as the Internet or a private line. Further, the input support server 20 can access the language database 30 through such a communication network.

The user terminal 10 is a computer that is used by a user who intends to create English text. The variety of the user terminal 10 is not particularly limited, and it may be a stationary or portable personal computer, or a mobile terminal such as an advanced mobile phone (smart phone), a cellular phone or a personal digital assistant (PDA), for example. The number of user terminals 10 in the input support system 1 is also not limited. The user terminal 10 includes an editor 11 that performs input and display of letters. Although the editor 11 has the function of communicating with the input support server 20 in this embodiment, a specific way of implementing the editor 11 is not particularly limited. For example, the editor 11 may be implemented on a web browser or may be incorporated in a specific word processor application program.

The input support server 20 is a computer that, when a romanized Japanese word is input or an English word is input, searches for input candidates based on the input letter string and presents the results to a user. To perform this processing, the input support server 20 refers to the language database 30.

The language database 30 is a device that stores parallel translation in English and Japanese. Specific structures (aspects) of the language database 30 and the data stored therein are not limited as long as the correspondence between English words/phrases and romanized Japanese words/phrases can be specified.

For example, an existing dictionary database or corpus may be used as the language database 30. Note that, however, because an input letter string is represented in Roman letters, Japanese in the language database 30 needs to be at least in Roman letters. As a matter of course, Japanese in the language database 30 may be also in hiragana, katakana or kanji, in addition to Roman letters. The language database 30 may be composed of a bilingual database in English and Japanese in hiragana, katakana or kanji (Japanese in kana etc.) and a translation table showing the correspondence between Japanese in kana etc. and Japanese in Roman letters. In this embodiment, the editor 11 sorts input candidate English phrases by the meaning in Japanese and displays them, and therefore information about the meaning in Japanese (for example, information of a case frame dictionary) is added to each phrase in advance.

Further, the language database 30 may contain not only parallel translation data but also data indicating a list of English words/phrases. Because the input support system 1 performs two types of search as shown in FIG. 1, it may refer to a different database or storage area for each search processing. For example, the input support system 1 may use a database that stores English only when making a search from English, and it may use a database that stores parallel translation in two languages when making a search from Japanese.

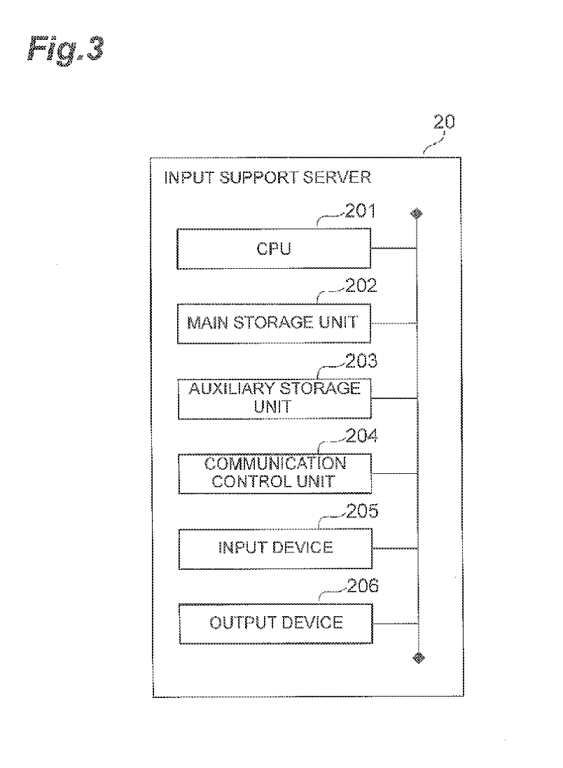

The functions and configuration of the input support server 20 are described hereinbelow. FIG. 3 shows the hardware configuration of the input support server 20. As shown therein, the input support server 20 includes a CPU 201 that executes an operating system, an application program and the like, a main storage unit 202 such as ROM and RAM, an auxiliary storage unit 203 such as a hard disk, a communication control unit 204 such as a network card, an input device 205 such as a keyboard and a mouse, and an output device 206 such as a display.

The functional elements of the input support server 20, which are described later, are implemented by loading given software onto the CPU 201 or the main storage unit 202, making the communication control unit 204, the input device 205, the output device 206 and the like operate under control of the CPU 201, and performing reading and writing of data in the main storage unit 202 or the auxiliary storage unit 203. The data and databases required for processing are stored in the main storage unit 202 or the auxiliary storage unit 203. Note that, although the input support server 20 is composed of one computer in FIG. 3, the functions of the input support server 20 may be distributed among a plurality of computers.

As shown in FIG. 2, the input support server 20 includes a receiving unit 21, a search unit 22, and a providing unit (output unit) 23 as functional elements.

The receiving unit 21 is a functional element that receives an alphabetical input letter string. The editor 11 of the user terminal 10 transmits an input letter string to the input support server 20, and the receiving unit 21 receives the input letter string and outputs the letter string to the search unit 22.

The timing when the editor 11 transmits the input letter string to the input support server 20 is not limited. For example, the editor 11 may transmit a letter string to the input support server 20 only after it receives the input of the letter string with a specified length or more (for example, a letter string with two or three or more letters). By setting the lower limit of the length of a letter string to be received by the receiving unit 21, it is possible to reduce the load on search for a word or a phrase and reduce the number of input candidates to be displayed on the user terminal 10 to enhance the user-friendliness of the editor 11. Alternatively, the editor 11 may transmit the input letter string when a delimiter (space) is input. By using one word as the input letter string, it is possible to further reduce the load on search and further reduce the number of input candidates.

Alternatively, the editor 11 may transmit the input letter string when key entry is not made for a specified length of time (for example, two seconds etc.). As another way, the editor 11 may transmit the input letter string when a user presses a search button, a send button or the like. According to those two techniques, it is possible to transmit the input letter string composed of a plurality of words delimited by a space to the input support server 20.

The receiving unit 21 or the editor 11 may automatically specify a plurality of words from the input letter string with no delimiter. For example, when the receiving unit 21 or the editor 11 receives the letter string “nimotsuwookuru” (which corresponds to “send a package” in English), it may regard the letter string as Japanese in Roman letters and perform morphological analysis, and thereby specify three words “nimotsu”, “wo” and “okuru”, and then outputs those words to the search unit 22. In such word separation, the receiving unit 21 or the editor 11 may delete a specific word (for example, Japanese particles) which is less necessary for search and output only the remaining words (for example, nouns, verbs etc.) to the search unit 22. For example, the receiving unit 21 or the editor 11 may delete “wo”, which is Japanese particle, and output only the noun “nimotsu” and the verb “okuru” to the search unit 22.

The search unit 22 is a functional element that acquires input candidates corresponding to the input letter string from the language database 30. The search unit 22 acquires English words/phrases by two different ways as shown in FIG. 1.

First, the search unit 22 acquires English (first language) words/phrases containing the input letter string as a first search result from the language database 30. In this first processing, the search unit 22 makes a search by regarding the input language as English. Thus, when a romanized Japanese word is input, the search unit 22 cannot acquire English words/phrases in the first processing (search from English). As a matter of course, even when a user means to input a Japanese word, if an English word containing that letter string happens to exist, the search unit 22 acquires one or more English words/phrases in this first processing.

For example, when the input letter string is “forg”, the search unit 22 acquires the words such as “forget”, “forgot” and “forgive” and the phrases such as “get forgotten”, “get forgetful” and “forgive A for B”.

Next, the search unit 22 acquires English (first language) words/phrases that correspond to a Japanese (second language) word/phrase containing the input letter string as a second search result. In this second processing, the search unit 22 makes a search by regarding the input language as Japanese, and thus, when an English word is input, the search unit 22 cannot acquire English words/phrases in the second processing (search from Japanese). As a matter of course, even when a user means to input an English word, if a Japanese word indicated by the letter string happens to exist, the search unit 22 acquires one or more English words/phrases in this second processing.

For example, when the input letter string is “okuru”, the search unit 22 acquires the words such as “send”, “give” and “lead” that can correspond to the Japanese word and the phrases such as “send e-mail to”, “e-mail the address of” and “lead a gracious life” that can correspond to the Japanese word. Because one Japanese word can correspond to a plurality of English words, there is a case where English words/phrases with a variety of meanings are extracted from one Japanese word like in this example.

Note that there are various techniques, such as prefix matching, exact matching, suffix matching and partial matching, to search for words/phrases from an input letter string. Further, there is a technique that searches for related words/phrases to an input word from a thesaurus (related words database) rather than seeing the sameness of actual letters. For example, the search unit 22 may extract the related word “kamotsu” of the Japanese word “nimotsu” and the related word “soufu” to the Japanese word “okuru” from a thesaurus and acquire English words/phrases from the language database 30 by using those two related words. There are various search techniques as described above, and the search unit 22 may search for words/phrases by using any one or more techniques.

The search unit 22 outputs the first and second search results obtained by the above-described two types of processing to the providing unit 23. At this time, the search unit 22 adds, to each of the acquired English words/phrases, a flag indicating whether the word/phrase has been extracted by the search from English (first processing) or extracted by the search from Japanese (second processing). Note that, as a matter of course, both of the first and second search results can be NULL due to a typing error by a user.

In the case where the input letter string contains a plurality of words, the search unit 22 may make the above-described two types of search for each word and thereby finally acquire a common phrase that is extracted for all of the input words (search for a common phrase). By searching for input candidates by using all of the words that form the input letter string, it is possible to present the word/phrase which a user intends to input with high probability. In the search for a common phrase, the input letter string may be composed only of English words, composed only of Japanese words, or may be a combination of Japanese and English words. For example, in any of the cases where the input letter string contains two English words “send” and “package”, where it is composed of two Japanese words “okuru” (which corresponds to “send” in English) and “nimotsu” (which corresponds to “package” in

English), and where it is composed of the Japanese word “nimotsu” and the English word “send”, the search unit 22 searches for the phrase “send a package” (which has the meaning of “nimotsu wo okuru” in Japanese).

As another processing method in the case where the input letter string contains a plurality of words, the search unit 22 may make the above-described two types of search only for a certain word among those words (search with a certain word). For example, the search unit 22 may make the above-described two types of search only for the word at the end of the input letter string. By searching for input candidates by using a certain word only, it is possible to avoid the situation where too many or too few English words/phrases are extracted.

As another method, the search unit 22 may make both of the search for a common phrase and the search with a certain word and acquire those two types of search results. In this case, the search unit 22 adds, to each of the words/phrases acquired as input candidates, a flag to distinguish between the word/phrase acquired by the search for a common phrase and the word/phrase acquired by the search with a certain word.

The providing unit 23 is a functional element that transmits the search results by the search unit 22 as input candidates to the user terminal 10. As described above, a flag indicating by which search the word/phrase has been extracted is associated with each of the English words/phrases in the search results. In the user terminal 10, the editor receives the input candidates and displays them on the screen.

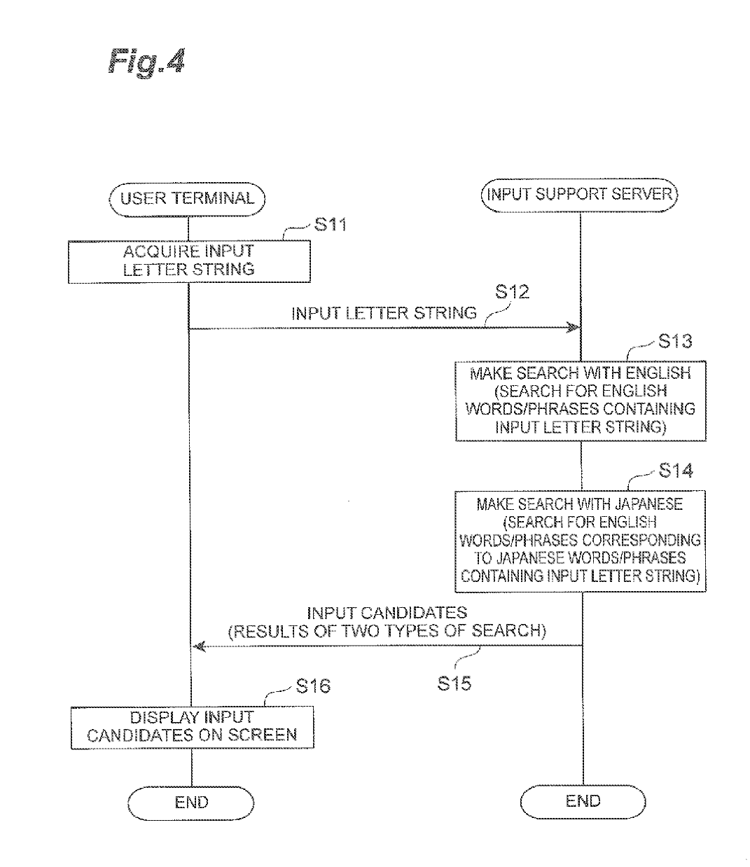

The operation of the input support system 1 and an input support method according to this embodiment are described hereinafter with reference to FIG. 4.

First, in the user terminal 10, the editor 11 acquires a letter string with a specified length or more that is input in alphabets (Step S11) and transmits the input letter string to the input support server 20 (Step S12).

In the input support server 20, the receiving unit 21 receives the input letter string (Step S12, receiving step), and then the search unit 22 searches for input candidates based on the letter string. To be specific, the search unit 22 searches for English words/phrases containing the input letter string (Step S13, search step) and further searches for English words/phrases corresponding to the Japanese word/phrase containing the input letter string (Step S14, search step). Note that the search unit 22 may make a search from Japanese (Step S14) and then make a search from English (Step S13). Finally, the providing unit 23 transmits the two types of search results as input candidates to the user terminal 10 (Step S15, output step).

In the user terminal 10, the editor 11 receives the input candidates and displays them on the screen (Step S16, output step). A user can select one among the displayed input candidates, and the selected English word/phrase is displayed as a confirmed word/phrase on the editor 11.

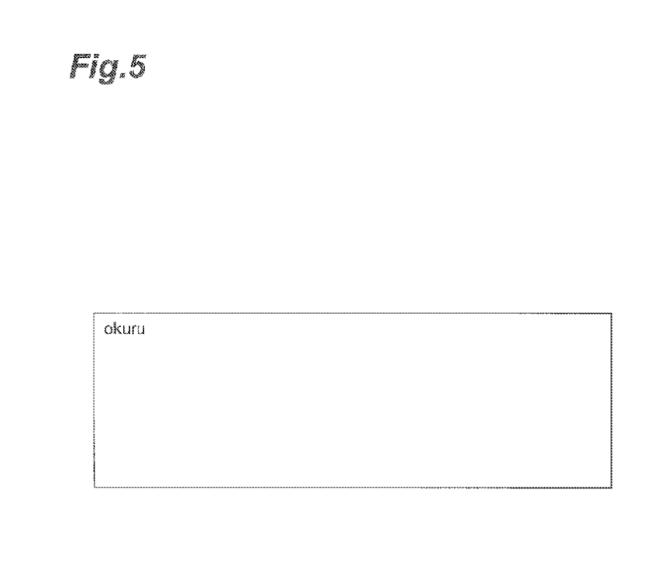

The way the input candidates are displayed on the editor 11 is described hereinafter with reference to FIGS. 5 to 13.

For example, as shown in FIG. 5, it is assumed that a user inputs the romanized Japanese word “okuru”. In this case, the editor 11 transmits the input letter string “okuru” to the input support server 20, and the search unit 22 performs two types of search based on this letter string. Because there is no English word containing “okuru”, the search unit 22 cannot acquire any English words/phrases by a search from English. On the other hand, because the Japanese word “okuru” has the meaning corresponding to several English words such as “send”, “give”, “present” and “lead”, the search unit 22 performs a search from

Japanese and thereby acquires English words/phrases. Thus, the providing unit 23 transmits one or a plurality of English words/phrases as input candidates to the user terminal 10, and the editor 11 displays the input candidates on the screen.

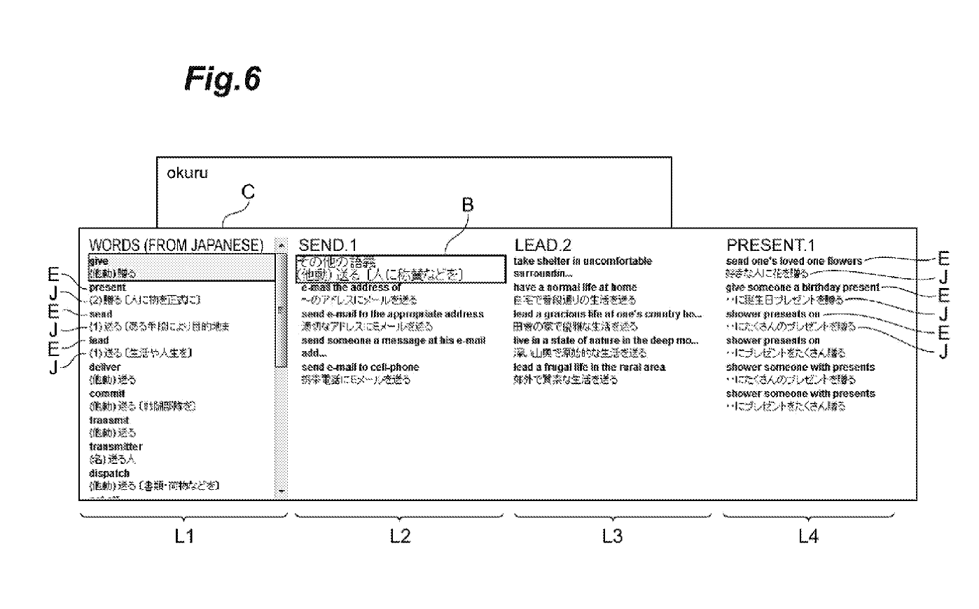

FIG. 6 shows an example of the input candidates displayed on the user terminal 10. In this figure, the editor 11 displays a list of input candidates in a candidate field C. For each of the retrieved English words/phrases E, Japanese translation J is shown. The title “word (from Japanese)” at the upper left of the candidate field indicates that the current words/phrases are obtained by a search from Japanese. The editor 11 can determine the title by referring to the flag associated with the acquired words/phrases.

In this figure, the editor 11 sorts and displays the input candidates into a list L of words that is displayed in the leftmost column and a list of phrases that is displayed in the other columns. Further, the editor 11 sorts the phrases into columns L2 to L4 by the meaning of the Japanese word “okuru”. In the example of FIG. 6, a scroll bar is displayed in the column L1 because there are many English words in comparison with the height of the candidate field C, and the editor 11 sets the scroll bar in each column in accordance with the number of words or the number of phrases in each column. A user can thereby overlook the words/phrases in one specific column, keeping looking the words/phrases in the other columns. If the number of groups made when sorting the English phrases by the meaning of the Japanese word is large compared with the width of the candidate field C, the editor 11 sets a horizontal scroll bar for overlooking the phrase columns.

In this manner, by sorting the input candidates into words and phrases or sorting the phrases by the meaning and then displaying the input candidates, a user can easily find and select a desired word/phrase. Note that the editor 11 may sort the acquired words/phrases only by the meaning and display them, without sorting those words/phrases into words and phrases. In this case also, a user can easily find and select a desired word/phrase.

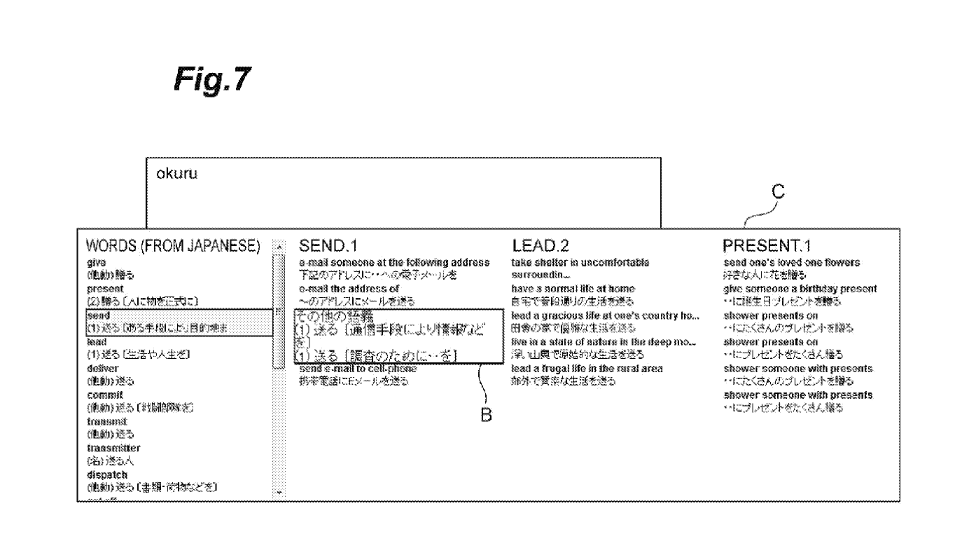

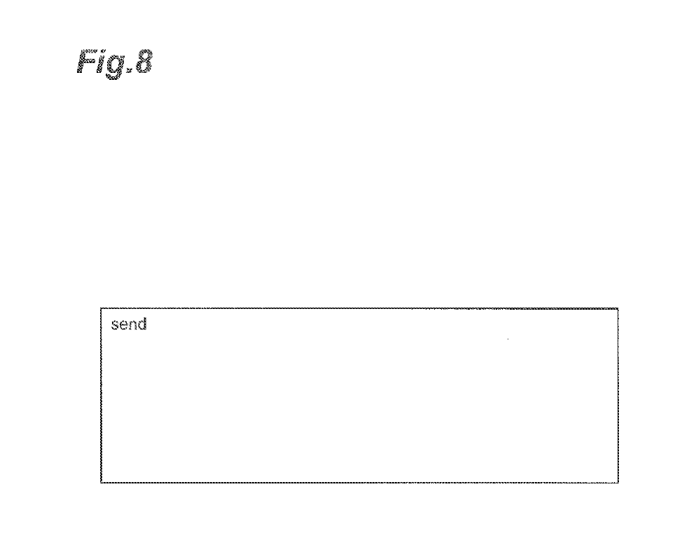

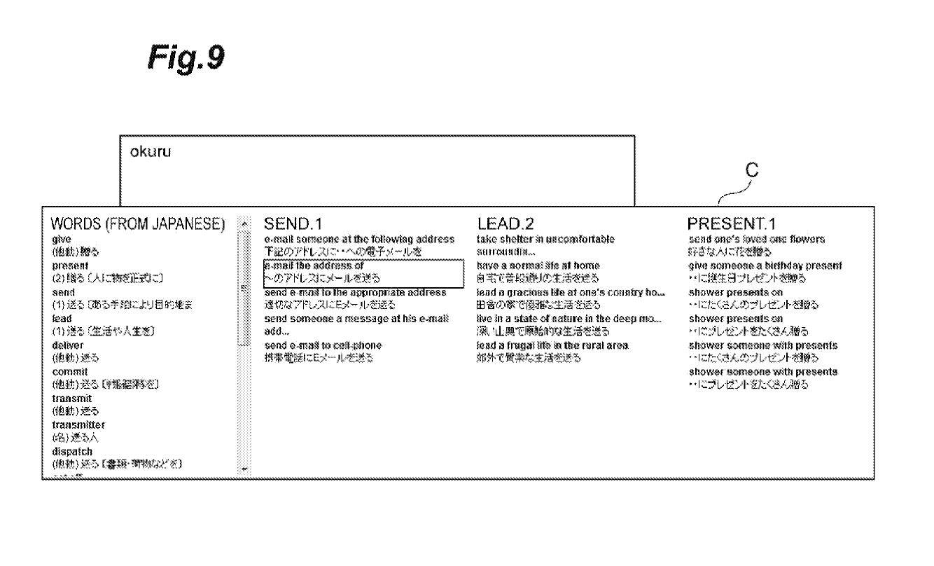

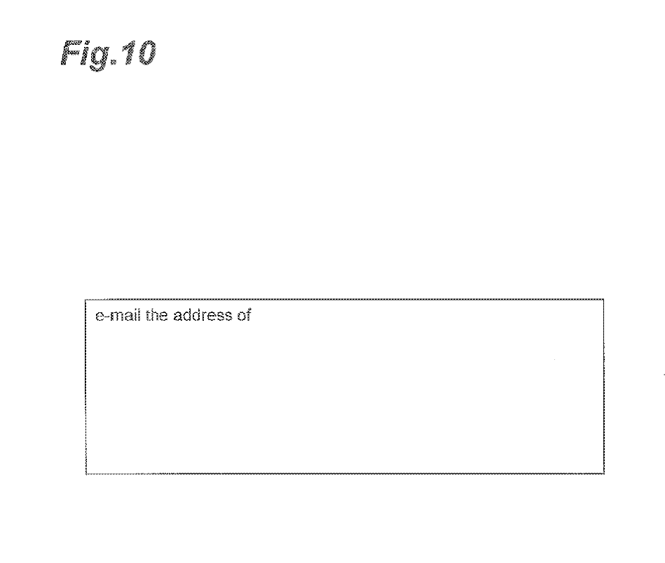

When the user selects the word “send” among the input candidates as shown in FIG. 7, the editor 11 displays that word, replacing the input letter string “okuru” as shown in FIG. 8. The input of “send” is thereby confirmed. On the other hand, when the user selects the phrase “e-mail the address of” among the input candidates as shown in FIG. 9, the editor 11 displays that phrase, replacing the input letter string “okuru” as shown in FIG. 10. The input of “e-mail the address of” is thereby confirmed.

Note that the other meanings of the selected word may be shown in the box B as shown in FIGS. 6 and 7.

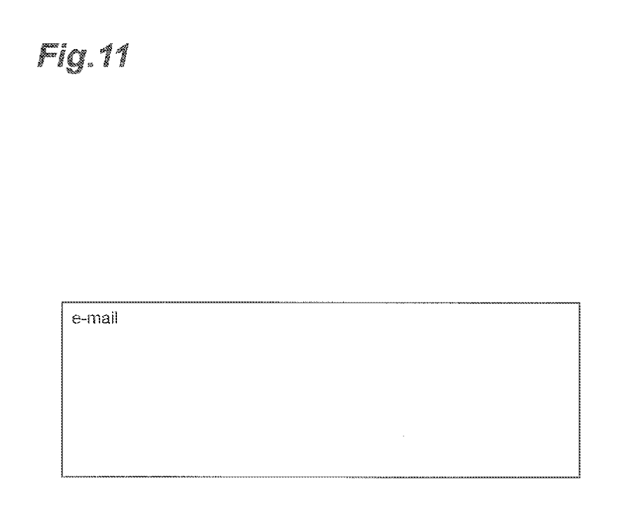

For another example, as shown in FIG. 11, it is assumed that a user inputs the alphabetical English word “e-mail”. In this case, the editor 11 transmits the input letter string “e-mail” to the input support server 20, and the search unit 22 performs two types of search based on the letter string. Because there is no romanized Japanese word “e-mail”, the search unit 22 cannot acquire any English words/phrases by a search from Japanese. On the other hand, the search unit 22 can acquire English words/phrases containing “e-mail” by making a search from English as a matter of course. Note that, even when the input letter string is “e-mai”, the same result is obtained. Thus, the providing unit 23 transmits one or a plurality of English words/phrases as input candidates to the user terminal 10, and the editor 11 displays the input candidates on the screen.

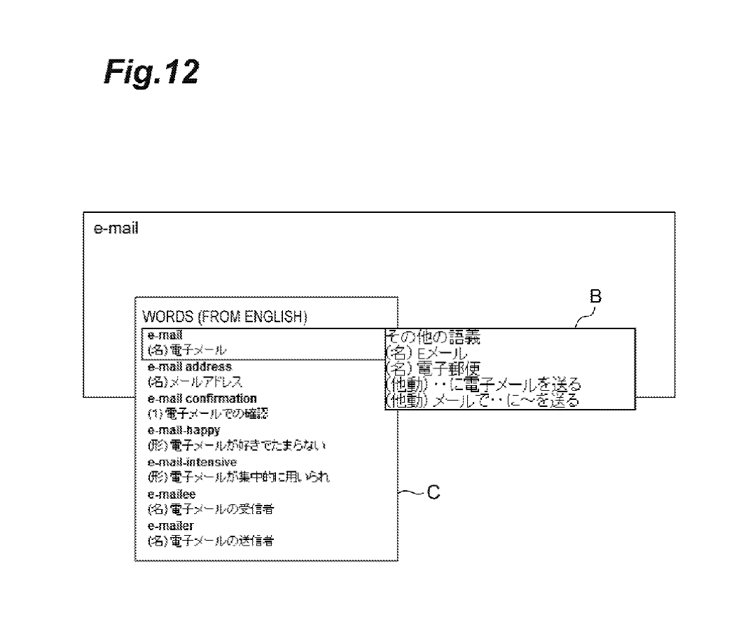

FIG. 12 shows an example of the input candidates displayed on the user terminal 10 in this case. In this example also, the editor 11 shows Japanese translation for each of the English words/phrases in the candidate field C. In FIG. 12, “e-mail” having a plurality of meanings is focused, and the descriptions of the other meanings are displayed in the box B by this focus setting. Note that, however, whether to implement the function of the box B in the editor 11 may be determined arbitrarily. When a user selects one word or phrase among the input candidates, the editor 11 displays the selected word/phrase, replacing the input letter string “e-mail”, and the input is thereby confirmed.

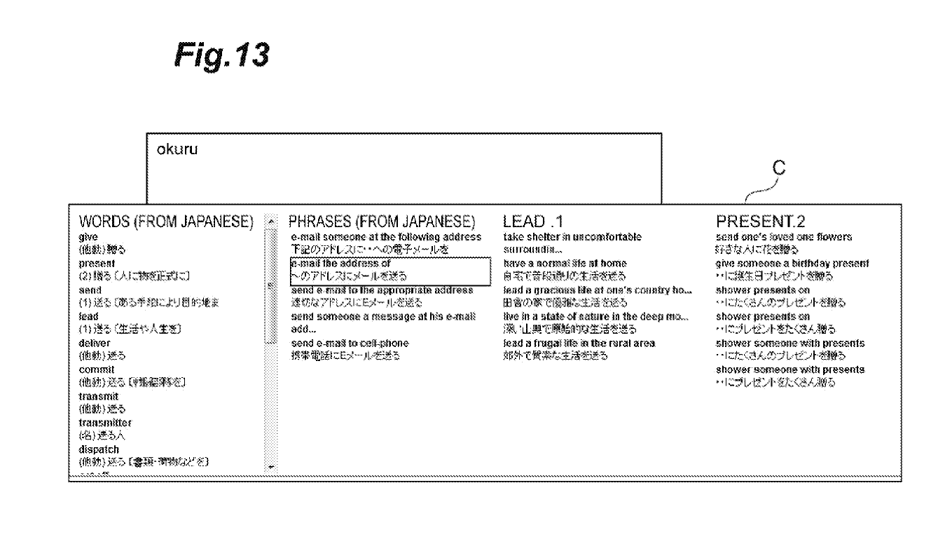

FIG. 13 shows one example of input candidates in the case where the input letter string contains a plurality of words. In the column L1, a list of English words corresponding to the Japanese word “okuru” at the end of the input letter string is shown. In the column L2, a list of English phrases containing the translations of both of the two Japanese words “nimotsu” and “okuru” contained in the input letter string is shown. In the columns L3 and L4, a list of English phrases containing the translation of the Japanese word “okuru” at the end of the input letter string is shown. The editor 11 can determine in which column each phrase should be displayed by referring to the flag associated with each of the phrases.

In the example of FIG. 13, when a user selects one English word from the column L1 or selects one phrase from the column L3 or L4, the editor 11 replaces only the word “okuru” at the end of the input letter string with the selected word and then confirms the input. In other words, the editor 11 replaces only the word that is used as the search conditions for English words/phrases in the input support server 20 with the word/phrase specified by a user. In this case, the user can find which word is replaced.

On the other hand, when a user selects a phrase from the column L2, the editor 11 replaces the two Japanese words “nimotsu” and “okuru” contained in the input letter string with the selected phrase and then confirms the input. Thus, a user can immediately proceed to the next editing work. The editor 11 can determine a part of the input letter string to be replaced by referring to the flag of each word/phrase in the input candidates.

It should be noted that, although the input letter string contains two words in the example of FIG. 13, the input letter string may contain three or more words as described above. For example, the input letter string may contain three Japanese words “okuru”, “nimotsu” and “koukuubin (which corresponds to “airmail” in English)”.

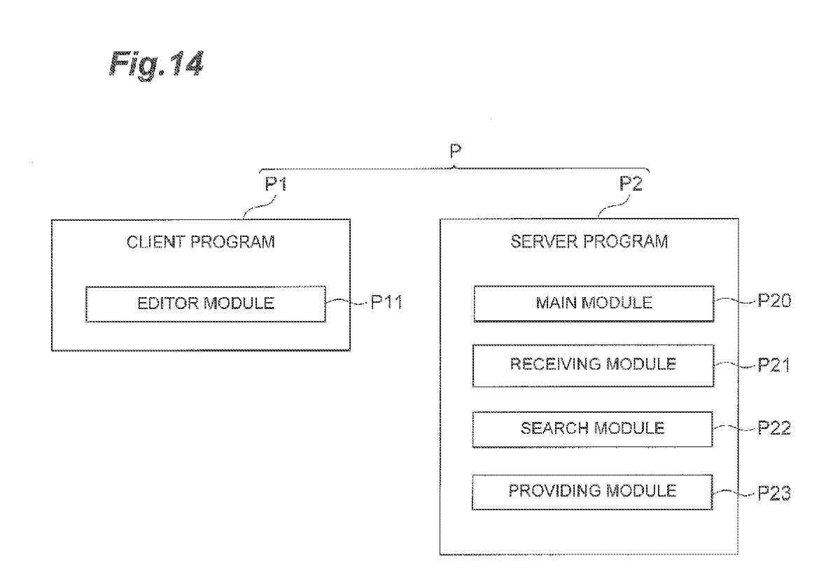

An input support program P for implementing the input support system 1 is described hereinafter with reference to FIG. 14. The input support program P includes a client program P1 for implementing the functions of the editor 11 in the user terminal 10 and a server program P2 for causing a computer to function as the input support server 20.

The client program P1 includes an editor module P11, and the functions of the editor 11 are implemented by this module.

The server program P2 includes a main module P20, a receiving module P21, a search module P22, and a providing module P23. The main module P20 is a part that exercises control over the functions of the input support server 20. The functions implemented by executing the receiving module P21, the search module P22 and the providing module P23 are equal to the functions of the receiving unit 21, the search unit 22 and the providing unit 23 described above, respectively.

The client program P1 and the server program P2 are provided in the form of being recorded in a static manner on a tangible recording medium such as CD-ROM or DVD-ROM or semiconductor memory, for example. Further, the programs P1 and P2 may be provided as a data signal superimposed onto a carrier wave through a communication network.

As described above, according to this embodiment, processing that searches for words/phrases with an input letter string without translation (search from English) and processing of translation based on the input letter string (search from Japanese) are performed, and English words/phrases obtained from those two types of processing are all output as input candidates. In general, a user needs to input a sentence or sentences after performing an operation of switching the input mode or the like. On the other hand, in this embodiment, because two systems of processing are performed for one input letter string and search results of the both are output, a user can input a target language word/phrase without specifying the language of an input letter string (without switching the input mode, for example).

### Second Embodiment

An input support system 2 according to a second embodiment is described hereinbelow. This system 2 is different from the system of the first embodiment (the input support system 1) in that, when a user selects one word/phrase from input candidates and confirms the input, words/phrases that are applicable to a slot of the word/phrase are further presented. For this purpose, the input support system 2 includes an input support server 20A.

“Slot” in this specification is an unconfirmed part that is set to one word/phrase selected from input candidates, and an object, a complement or the like can be inserted into the unconfirmed part. The slot is set before or after a word, or before, after or in the middle of a phrase. For example, “someone” in the phrase “give someone a birthday present” is the slot that is set in the middle of the phrase. For another example, a part that follows the phrase “e-mail the address of” can be set as the slot. Further, “A” and “B” in the phrase “provide A with B” are also one example of the slot. By providing words/phases that are applicable to such a slot as well, it is expected to further simplify the text input.

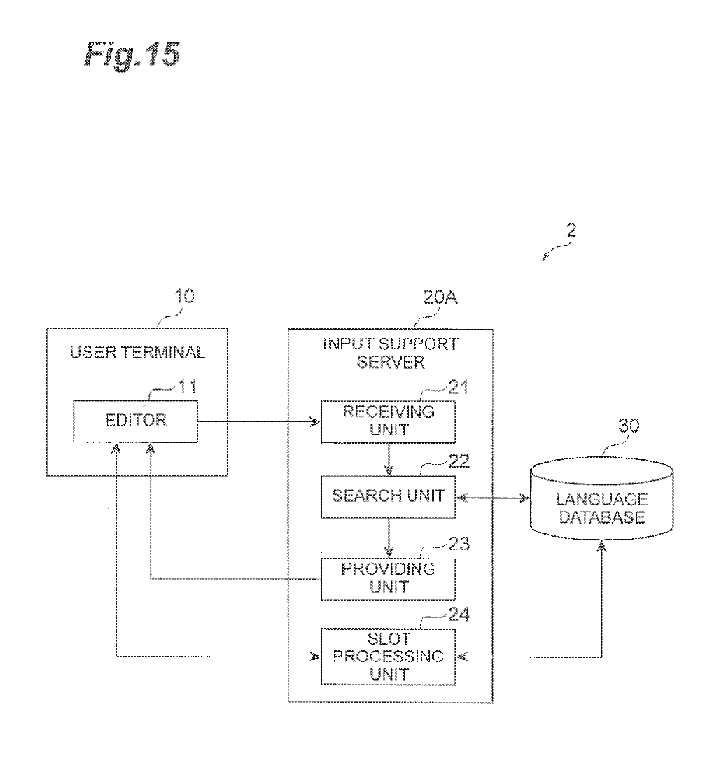

As shown in FIG. 15, to implement the above-described additional functions, the input support server 20A according to this embodiment includes a slot processing unit (additional processing unit) 24 in addition to the three functional elements in the first embodiment. Further, the editor 11 further has the function for obtaining words/phrases that are likely to be applicable to the slot. Furthermore, information indicating the position of the slot is associated in advance with at least some of English words/phrases that can be displayed as input candidates on the user terminal 10.

After the user selects one word/phrase among the input candidates, the editor 11 confirms the input of the word/phrase and then transmits information of the word/phrase to the input support server 20A. Further, the editor 11 sets a focus on the position of the slot. When there are a plurality of slots, the editor 11 sets a focus on one slot (for example, the slot at the head) among them. After that, the editor 11 receives additional input candidates that are transmitted from the input support server 20 in response to the transmission of information about the confirmed word/phrase, and displays the input candidates on the screen. The additional input candidates are words/phrases that can be inserted into the slot.

The slot processing unit 24 is a functional element that, when the input of an English word/phrase having a slot is confirmed, acquires English words/phrases that can be inserted into the slot and outputs the acquired words/phrases as additional input candidates. The slot processing unit 24 acquires the words/phrases that are likely to be inserted into the slot based on information about the confirmed word/phrase received from the editor 11, and transmits the processing result to the user terminal 10.

A method of searching for words/phrases that are applicable to a slot is not limited. As a first method, on the assumption that an English word/phrase having a slot and words/phrases that can be inserted into the slot are stored in association with each other in the language database 30, the slot processing unit 24 may extract words/phrases that can be inserted into the slot of the confirmed word/phrase from the language database 30.

Alternatively, as a second method, the slot processing unit 24 may determine words/phrases that can be inserted into the slot of the confirmed word/phrase by using a technique of the existing natural language processing. For example, the slot processing unit 24 may obtain additional input candidates by using the technique of n-gram on English text and further obtain additional input candidates by referring to the parallel translation data containing information of a case frame dictionary. In this manner, the slot processing unit 24 can obtain additional input candidates by using both of a search from English and a search from Japanese, just like the acquisition of input candidates (first input candidates) described in the first embodiment. In this case, the slot processing unit 24 associates a flag indicating by which of the two types of search processing the word/phrase is obtained with that word/phrase. Note that the natural language processing used in this processing is not limited to the n-gram and the case frame dictionary, and any method can be used.

Alternatively, as a third method, the slot processing unit 24 may extract additional input candidates by searching an English corpus in the language database 30. To be specific, the slot processing unit 24 extracts sentences containing the confirmed word/phrase, analyzes the one or more extracted sentences and specifies the words/phrases that are actually inserted into the position of the slot and the number of times they appear. Then, the slot processing unit 24 creates a list by sorting the one or more specified words/phrases in descending order of the number of appearances, and sets the list as the additional input candidates. For example, for the confirmed word/phrase “give someone a birthday present”, the slot processing unit 24 sets the word group “you”, “her”, “him” and “Tom” as the additional input candidates in the descending order of the number of appearances. By setting the order of display according to the number of appearances, the word that is highly likely to be selected can be presented to a user in preference to the word that is less likely to be selected. Alternatively, the slot processing unit 24 may set a word that is not very frequent but is characteristic subsequent word as the additional input candidate by using PMI (Pointwise Mutual Information) or the like.

Alternatively, as a fourth method, the slot processing unit 24 may analyze the sentence or sentences located before the current confirmed word/phrase on the editor and thereby specify the words/phrases that are likely to be inserted into the slot. For example, it is assumed that the sentences “His birthday is in December. I will” are already input. In this case, when a user inputs “okuru” and selects the phrase “give someone a birthday present” from the input candidates displayed in response to the input operation, the slot processing unit 24 extracts “him” as the additional input candidate by using the word “His” as a clue. In this fourth method, the slot processing unit 24 needs to receive not only information of the confirmed word/phrase but also information of the sentence or sentences located before it from the editor 11. According to the fourth method, it is possible to present in advance words/phrases which a user who inputs a sentence or sentences is likely to be about to input.

Alternatively, the slot processing unit 24 may display the word included in the word group extracted by the third method and derived by the fourth method in preference to the word not derived by the method (fifth method). For example, the slot processing unit 24 may set the order of display of each word in the word group so that the word derived by the fourth method is displayed earlier than the other words.

As described above, the method of acquiring words/phrases that can be inserted into a slot is not particularly limited. Further, the order of display of the words/phrases is also not limited to the above, and the slot processing unit 24 may display the acquired words in alphabetical order.

In the case where there are a plurality of slots, the slot processing unit 24 may extract additional input candidates by an arbitrary method (for example, any of the first to fifth methods described above) for each slot.

Further, the slot processing unit 24 may transmit to the editor 11 information about a natural combination of words/phrases that are respectively inserted into at least two slots among a plurality of slots and the words/phrases that can be inserted into the respective slots. Note that the combination information may be stored in the language database 30 or prestored in the slot processing unit 24.

For example, it is assumed that there are two English words “rent” and “borrow” as candidates for a first slot, and there are two English words “library” and “rental shop” as candidates for a second slot. In this case, the slot processing unit 24 reads combination information Ca indicating that the combination of “library” and “borrow” is more natural than the combination of “library” and “rent” and combination information Cb indicating that the combination of “rental shop” and “rent” is more natural than the combination of “rental shop” and “borrow” from the language database 30 and transmits them to the editor 11.

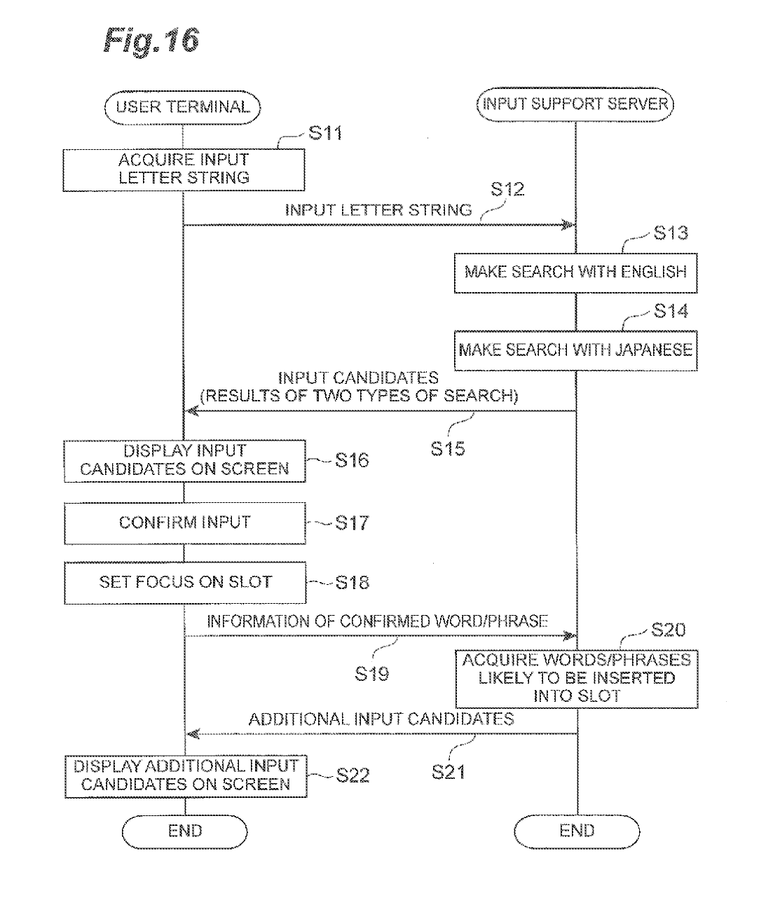

The operation of the input support system 2 and an input support method according to this embodiment are described hereinafter with reference to FIG. 16.

The processing of Steps S11 to S16 is the same as in the first embodiment. After that, when a user selects one word/phrase from the input candidates and confirms the input (Step S17), the editor 11 sets a focus on the slot of the confirmed word/phrase (Step S18).

For example, when the confirmed word/phrase is “give someone a birthday present”, the editor 11 sets a focus on the whole of the word “someone”. For another example, when the confirmed word/phrase is “e-mail the address of”, the editor 11 sets a focus on the position after “of”. By setting the position of the focus in this manner, a user can immediately proceed to the next editing work without performing an operation of moving a cursor or the like. For example, by setting a focus on the whole word, a user can immediately overwrite the word by selection from input candidates or by direct input. In addition to such focus setting, the editor 11 transmits information of the confirmed word/phrase to the input support server 20 (Step S19).

In the input support server 20, the slot processing unit 24 receives the information (Step S19) and acquires English words/phrases that can be inserted into the slot by any of the above-described methods (Step S20). Then, the slot processing unit 24 transmits the extracted words/phrases as additional input candidates to the user terminal 10 (Step S21).

In the user terminal 10, the editor 11 receives the additional input candidates and displays them on the screen (Step S22). When a user selects one of the candidates, the selected English word/phrase is inserted into the slot, and thereby the input is confirmed.

In the case where there are a plurality of slots, the editor 11 may confirm the word/phrase of each slot one by one based on a user's selection. Alternatively, the editor 11 may confirm the words/phrases of all slots at once after a user has made selections for all slots and thereby give a user an opportunity to select the word/phrase of each slot again.

In the case where the combination information is received, the editor 11 may automatically select and present the word/phrase of another slot that naturally matches the word/phrase selected by a user in one slot, or present a more natural word/phrase as help information to a user without automatic selection, based on the received information. By presenting a natural combination of words/phrases in this manner, a user can easily create a natural sentence or sentences.

For example, it is assumed that the editor 11 receives two English words “rent” and “borrow”, which are candidates for a first slot, English words “library” and “rental shop”, which are candidates for a second slot, and the above-described combination information Ca and Cb. Then, it is assumed that a user selects “rent” for the first slot and then selects “library” for the second slot. In this case, the editor 11 replaces the “rent” in the first slot with “borrow”, or display help information indicating that “borrow” is a more natural word, in response to the user operation.

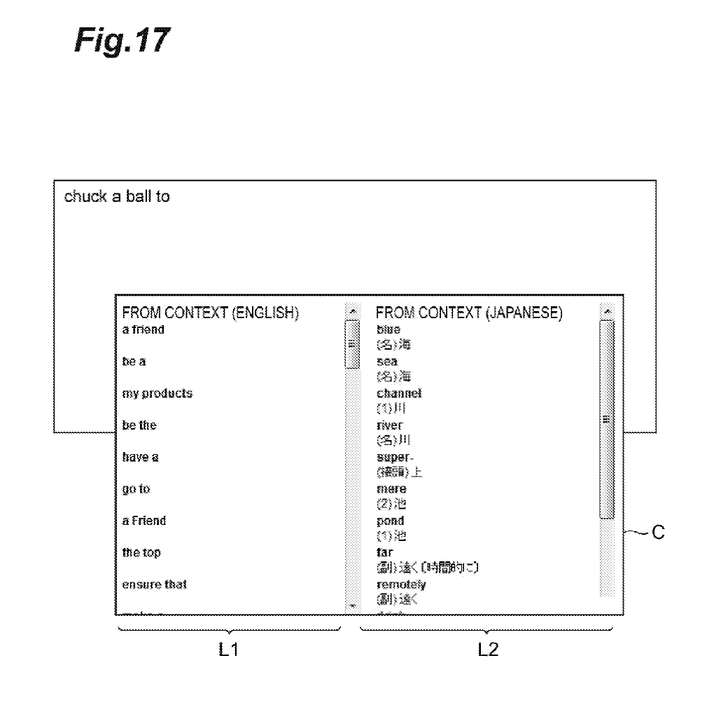

The way the additional input candidates are displayed on the editor 11 is described hereinafter with reference to FIG. 17.

It is assumed that the English phrase “chuck a ball to” is selected from input candidates and thereby the input is confirmed. In this case, the editor 11 transmits information of this phrase to the input support server 20. Then, the slot processing unit 24 acquires additional input candidates based on this phrase and transmits the candidates to the user terminal 10.

Then, the editor 11 displays the additional input candidates on the screen as shown in FIG. 17. In this figure, the editor 11 displays a list of the additional input candidates in the candidate field C. In this example, the additional input candidates are sorted into words/phrases obtained by a search from English (column L1) and words/phrases retrieved by a search from Japanese (column L2) and displayed. Which of the two groups each word/phrase belongs to can be determined by referring to the flag associated with the word/phrase. As shown in FIG. 17, when displaying the additional input candidates also, the editor 11 may set the scroll bar in each column in accordance with the number of words or the number of phrases in each column.

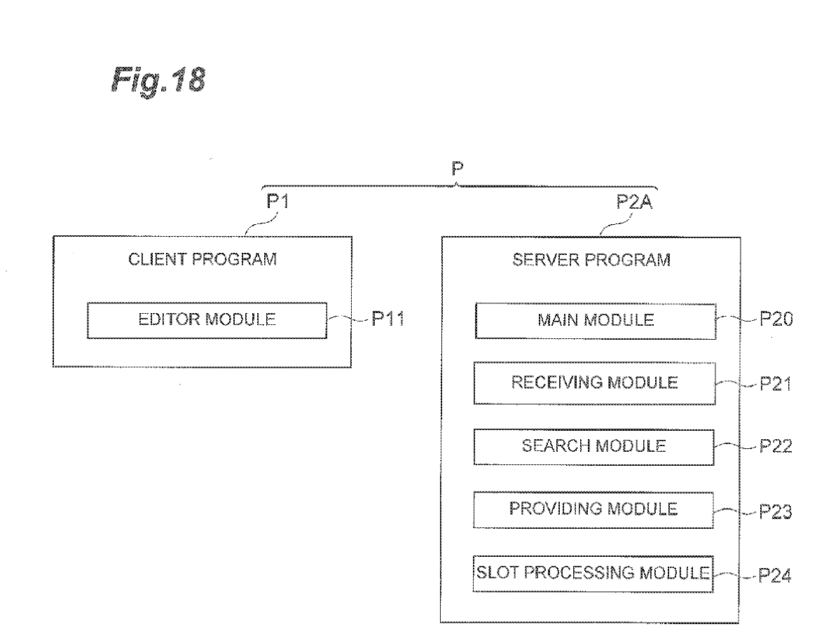

An input support program P for implementing the input support system 2 is described hereinafter with reference to FIG. 18. The input support program P according to this embodiment is different from that of the first embodiment in that a server program P2A includes a slot processing module P24 in addition to the main module P20, the receiving module P21, the search module P22, and the providing module P23. The function implemented by executing the slot processing module P24 is equal to the function of the slot processing unit 24 described above.

The above-described second embodiment has the same advantageous effects as the first embodiment. In addition, according to this embodiment, immediately after the input of a word/phrase having a slot is confirmed, candidates (additional input candidates) for a word/phrase that can be inserted into the slot are presented, and therefore a user can more easily create a sentence or sentences.

Embodiments of the present invention are described in detail above. However, the present invention is not limited to the above-described embodiments. Various changes and modifications may be made to the present invention without departing from the scope of the invention.

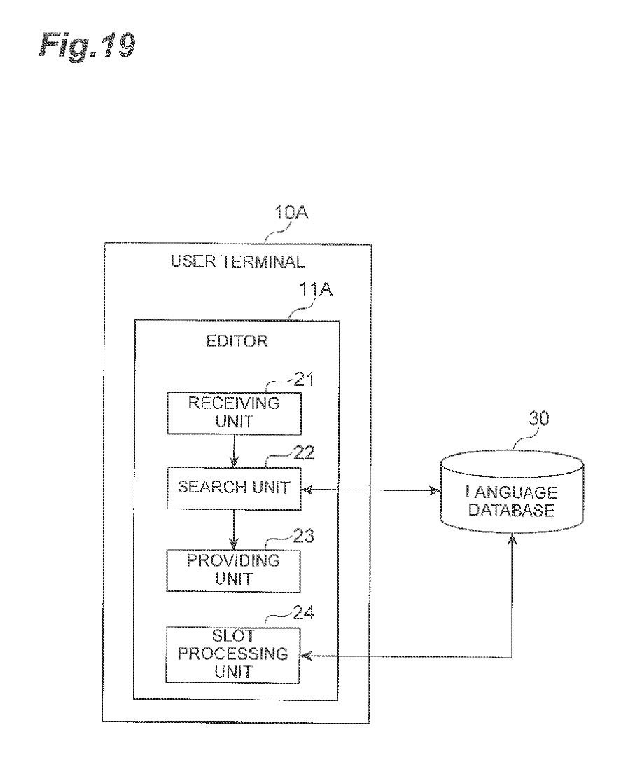

Although the client-server input support system is described in the above embodiments, the input support device in which the user terminal or the editor has the functions of the input support server 20 or 20A may be employed. For example, as shown in FIG. 19, an editor 11A implemented in a user terminal 10A may include the receiving unit 21, the search unit 22, providing unit 23 and the slot processing unit 24. In this case, the search unit 22 and the slot processing unit 24 access the language database 30 through a network.

In the above-described embodiments, the language database 30 may be located in the input support server 20 or 20A. Likewise, in the alternative example of FIG. 19, the language database 30 may be located in the user terminal 10A.

In the above-described embodiments, the input support system receives the input of English or the input of Japanese in Roman letters in order to support the input of English text. In other words, in the above embodiments, the first language is English, and the second language is Japanese. However, which language is the first and second language may be set arbitrarily. Note that, however, the first language is a language that is represented using alphabets (for example, French, German). On the other hand, the second language may be a language that is not usually represented using alphabets but can be represented using alphabets (for example, Chinese) or a language that is represented using alphabets (for example, French, German, English). Accordingly, both of the first and second languages may be a Latin language.

The way of displaying the input candidates and the additional input candidates on the editor is also not limited. For example, the editor 11 may display one scroll bar for the whole candidate field C or sort and display the input candidates into only two columns: a column of words and a column of phrases. Alternatively, hidden words/phrases may be displayed using a technique of page switching rather than the scroll bar.

In the above-described second embodiment, the editor 11 sets a focus on a slot and then displays the additional input candidates after that. Note that, however, the input support system may end the process at the time of setting a focus on a slot and refrain from acquiring the additional input candidates.

### REFERENCE SIGNS LIST

1,2 . . . input support system, 10,10A . . . user terminal, 11,11A . . . editor, 20,20A . . . input support server, 21 . . . receiving unit, 22 . . . search unit, 23 . . . providing unit (output unit), 24 . . . slot processing unit (additional processing unit), 30 . . . language database (storage unit), P . . . input support program, P1 . . . client program, P11 . . . editor module, P2,P2A . . . server program, P20 . . . main module, P21 . . . receiving module, P22 . . . search module, P23 . . . providing module, P24 . . . slot processing module

1. An input support device comprising:
at least one memory operable to store program instructions;
at least one processor operable to read and carry out said program instructions, said program instructions including:
receiving instructions configured to cause at least one of said at least one processors to receive an input letter string in Roman letters;
search instructions configured to cause at least one of said at least one processors to perform first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string; and
output instructions configured to cause at least one of said at least one processors to output a result of the first processing and a result of the second processing as input candidates.

2. The input support device according to claim 1, wherein
the input letter string contains a plurality of words,
the search instructions are further configured to cause at least one of said at least one processors perform the first processing and the second processing for each of the plurality of words, and
the output instructions are further configured to cause at least one of said at least one processors to output a common word/phrase in the first language retrieved with all of the plurality of words as the input candidates.

3. The input support device according to claim 2, wherein
the common word/phrase in the first language selected by a user replaces the whole input letter string, and thereby input of the selected word/phrase is confirmed.

4. The input support device according to claim 1, wherein
the input letter string contains a plurality of words, and
the output instructions are further configured to cause at least one of said at least one processors to output words/phrases in the first language retrieved with a certain word among the plurality of words as the input candidates.

5. The input support device according to claim 4, wherein
the certain word is a word located at an end of the input letter string.

6. The input support device according to claim 4, wherein
the word/phrase in the first language selected by a user replaces only the word used as search conditions for the selected word/phrase among the plurality of words, and thereby input of the selected word/phrase is confirmed.

7. The input support device according to claim 1, wherein
the input candidates include a word/phrase in the first language to which information indicating an unconfirmed part is added, and
when input of the word/phrase having the unconfirmed part is confirmed, a focus is set on the unconfirmed part.

8. The input support device according to claim 1, wherein
the input candidates include a word/phrase in the first language to which information indicating an unconfirmed part is added, and
the input support device further includes slot processing instructions configured to cause at least one of said at least one processors to, when input of the word/phrase having the unconfirmed part is confirmed, acquire words/phrases likely to be inserted into the unconfirmed part and outputs the acquired words/phrases as additional input candidates.

9. The input support device according to claim 8, wherein
the slot processing instructions cause at least one of said at least one processors to acquire words/phrases likely to be inserted into the unconfirmed part by referring to a specified storage unit storing correspondence between an unconfirmed part of a word/phrase and words/phrases that can be inserted into the unconfirmed part.

10. The input support device according to claim 8, wherein
the slot processing instructions cause at least one of said at least one processors to acquire words/phrases likely to be inserted into the unconfirmed part by referring to a specified storage unit storing a corpus of at least one of the first language and the second language.

11. The input support device according to claim 10, wherein
the additional input candidates are displayed in an order according to the number of appearances in the corpus.

12. The input support device according to claim 8, wherein
the slot processing instructions cause at least one of said at least one processors to analyze a confirmed letter string located before the input letter string and thereby estimates a word/phrase likely to be inserted into the unconfirmed part.

13. The input support device according to claim 12, wherein
in the additional input candidates, a word/phrase estimated by analysis of the confirmed letter string is displayed in preference to a word/phrase not estimated by the analysis.

14. The input support device according to claim 8, wherein
when there are a plurality of unconfirmed parts in a word/phrase in the first language contained in the input candidates, the slot processing instructions cause at least one of said at least one processors to acquire the additional input candidates for each of the unconfirmed parts and acquire combination information indicating a natural combination between a word/phrase likely to be inserted into a first unconfirmed part and a word/phrase likely to be inserted into a second unconfirmed part, and output the combination information together with the additional input candidates for each of the unconfirmed parts, and
in response to a user operation in one of the first and second unconfirmed parts, a word/phrase likely to be inserted into another one of the unconfirmed parts is presented based on the combination information.

15. The input support device according to claim 1, wherein
the input candidates are sorted into a column of words and a column of phrases and displayed.

16. The input support device according to claim 15, wherein
the phrases are further sorted into a plurality of columns by meanings and displayed.

17. The input support device according to claim 1, wherein
the input candidates are sorted into a plurality of columns by meanings and displayed.

18. The input support device according to claim 15, wherein
the input candidates are displayed so that columns are scrolled independently of one another.

19. An input support method performed by an input support device including at least one processor, comprising:
receiving an input letter string in Roman letters;
performing first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string; and
outputting a result of the first processing and a result of the second processing as input candidates.

20. A non-transitory computer readable medium storing an input support program causing a computer to:
receive an input letter string in Roman letters;
perform first processing that searches a storage unit storing alphabetical words/phrases in a first language and romanized words/phrases in a second language corresponding to the words/phrases in the first language in a way their correspondence can be specified for words/phrases in the first language containing the input letter string, and second processing that searches the storage unit for words/phrases in the first language corresponding to the romanized word/phrase containing the input letter string; and
output a result of the first processing and a result of the second processing as input candidates.
